(19) United States
(12) Patent Application Publication
(10) Pub. No.: US 2026/0194393 A1
(43) Pub. Date: Jul. 9, 2026

(54) TUNABLE FILTER FOR REDUCING COMBUSTION GASES IN THERMAL IMAGES AND RELATED SYSTEMS AND METHODS

(71) Applicant: FLIR Systems AB, Täby (SE)

(72) Inventor: Jonas Sandsten, Lomma (SE)

(21) Appl. No.: 19/425,787

(22) Filed: Dec. 18, 2025

Related U.S. Application Data
(60) Provisional application No. 63/743,589, filed on Jan. 9, 2025.

(51) Int. Cl. G01J 5/0802; G01J 5/00; G01J 5/02; G01J 5/08; G01J 5/60

(52) U.S. Cl. CPC G01J 5/0802; G01J 5/0044; G01J 5/025; G01J 5/0859; G01J 5/601; G01J 2005/0077; G01J 2005/604

(57) ABSTRACT

Various techniques are provided for improved monitoring of furnace tubes through application of a tunable filter used to capture thermal images. In one example, a method includes receiving, at a tunable filter, thermal radiation from a furnace comprising a furnace tube and combustion gas. The method also includes adjusting a passband of the filter within a range of thermal wavelengths to provide filtered thermal radiation for subsets of the thermal wavelengths. The method also includes capturing thermal images of the filtered thermal radiation for the subsets. The method also includes processing the thermal images to select one of the subsets for which the furnace tube exhibits a maximum transmittance relative to the combustion gas. Additional methods and systems are also provided.

### CROSS REFERENCE TO RELATED APPLICATIONS

This application claims priority to and the benefit of U.S. Provisional Patent Application No. 63/743,589 filed Jan. 9, 2025 and entitled “TUNABLE FILTER FOR REDUCING COMBUSTION GASES IN THERMAL IMAGES AND RELATED SYSTEMS AND METHODS,” which is incorporated herein by reference in its entirety.

### TECHNICAL FIELD

The present invention relates generally to improved thermal imaging and, more particularly, to thermal imaging applied to the monitoring of furnace tubes.

### BACKGROUND

In industrial furnaces such as those provided in refineries, a liquid to be heated (e.g., crude oil) may be pumped through furnace tubes and heated as it flows therethrough (e.g., during a refining process). The heating may be performed by burning various fuels which results in different types of combustion gases in proximity to the furnace tubes.

Monitoring the temperatures of the furnace tubes during operation permits operators to verify that the furnace tubes are being maintained at desired temperatures to provide appropriate heating of the liquid (e.g., as part of a larger refining process) and reliable operation of the furnace.

For example, if the furnace tubes are incorrectly measured to have a lower temperature than their actual temperature, excess heating may occur which may result in an improper refining process, premature failure of the tubes, and/or catastrophic failure of furnace or refinery.

Conversely, if the furnace tubes are incorrectly measured to have a higher temperature than their actual temperature, insufficient heating may occur which may also result in an improper refining process and/or reduced efficiency of the furnace and refinery.

Conventional techniques for monitoring the temperature of furnace tubes are generally limited and sometimes problematic. For example, temperature sensors such as thermocouples are highly localized. As a result, such implementations may be unable to provide comprehensive temperature measurements over a large arrangement of furnace tubes. Indeed, unless a particular surface of a furnace tube is in direct proximity to a temperature sensor, an operator may be completely unaware if that surface exhibits abnormally high or low temperatures.

Although thermal imaging systems are sometimes used for monitoring, conventional thermal imaging techniques typically have a fixed spectral response and therefore are generally unable to provide consistent and repeatable measurements of furnace tube temperatures due to the presence of combustion gases within the furnace. For example, combustion gases may radiate thermal energy at various wavelengths within the range of wavelengths captured by a thermal imager. As a result, the thermal contributions of the combustion gases may interfere with the determination of the temperature of the furnace tubes (e.g., the combustion gases may obscure the furnace tubes).

Moreover, the use of different furnace fuels may result in different combustion gases that radiate thermal energy at different thermal wavelengths, further complicating the ability of a thermal imager to accurately measure the temperature of the furnace tubes.

### SUMMARY

Various techniques are disclosed to provide for improved monitoring of furnace tubes through application of a tunable (e.g., variable) filter used to capture thermal images. For example, a thermal camera may be provided with a tunable filter having an adjustable passband to permit thermal images to be captured for different narrow wavelength ranges. Thermal images may be captured while the passband is adjusted (e.g., swept) over a range of wavelengths. In various embodiments, such adjustment may be performed manually by a user and/or by a logic device of a camera (e.g., automatically).

In some embodiments, the filter may be implemented as a Fabry-Perot interferometer, a filter wheel, or any appropriate filter with a passband that may be selectively adjusted to filter thermal radiation over various narrow wavelength ranges.

The captured thermal images may be reviewed and processed (e.g., by a user and/or the logic device) to identify and select the wavelength range in which a desired feature (e.g., furnace tube) is highly visible (e.g., exhibits maximum transmittance) and interfering features (e.g., combustion gases) are highly attenuated.

For example, in some embodiments, the passband may exclude wavelengths associated with combustion gases. By adjusting the passband through various wavelengths, different types of combustion gases may be avoided.

In one embodiment, a method includes receiving, at a tunable filter, thermal radiation from a furnace comprising a furnace tube and combustion gas; adjusting a passband of the filter within a range of thermal wavelengths to provide filtered thermal radiation for subsets of the thermal wavelengths; capturing thermal images of the filtered thermal radiation for the subsets; and processing the thermal images to select one of the subsets for which the furnace tube exhibits a maximum transmittance relative to the combustion gas.

In another embodiment, a system includes a tunable filter configured to receive thermal radiation from a furnace comprising a furnace tube and combustion gas, wherein the filter comprises a passband adjustable within a range of thermal wavelengths to provide filtered thermal radiation for subsets of the thermal wavelengths; an imager configured to capture thermal images of the filtered thermal radiation for the subsets; and a logic device configured to select one of the subsets for which the furnace tube exhibits a maximum transmittance relative to the combustion gas.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a furnace with an imaging system in accordance with an embodiment of the disclosure.

FIG. 2 illustrates a block diagram of an imaging system in accordance with an embodiment of the disclosure.

FIG. 3 illustrates an additional block diagram of an imaging system in accordance with an embodiment of the disclosure.

FIG. 4 illustrates a tunable filter and other features of an optical system in accordance with an embodiment of the disclosure.

FIGS. 5-7 illustrate thermal radiance plots of various combustion gases in accordance with embodiments of the disclosure.

FIG. 8 illustrates a process of manually adjusting a passband of a tunable filter for capturing thermal images of furnace tubes in accordance with an embodiment of the disclosure.

FIG. 9 illustrates a process of adjusting a passband of a tunable filter by a logic device for capturing thermal images of furnace tubes in accordance with an embodiment of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

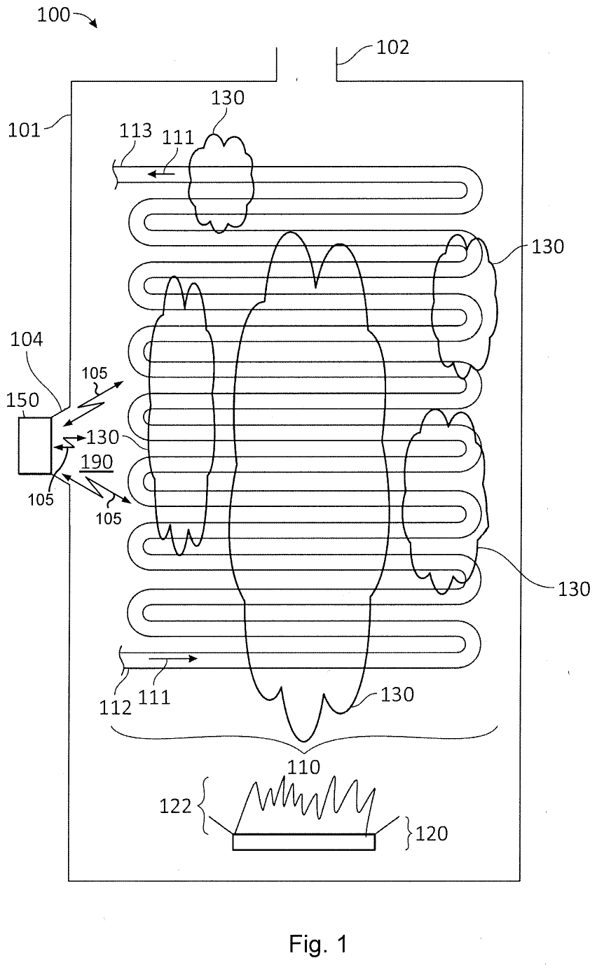

FIG. 1 illustrates a furnace 100 with an imaging system 150 in accordance with an embodiment of the disclosure. Furnace 100 may include enclosure 101 with furnace tubes 110 disposed therein and arranged to provide a path for a liquid 111 (e.g., crude oil) to pass therethrough. For example, liquid 111 may be pumped from an inlet portion 112 to an outlet portion 113 by one or more pumps or other appropriate apparatus (not shown). Imaging system 150 is positioned to capture thermal images of furnace tubes 110 in response to thermal radiation 105 received through an opening 104 (e.g., an aperture, a door, and/or other access location) in enclosure 101.

Furnace 100 further includes one or more burners 120 that heat furnace tubes 110 and consequently also heat liquid 111 passing therethrough. In some embodiments, burners 120 perform combustion of various fuels such as coal, gas, or other types. This combustion generates heat, flames 122, and various gases 130 (e.g., including combustion gases and vapors) within enclosure 101.

In some embodiments, furnace tubes 110 may be heated to various temperatures (e.g., in excess of 400 degrees C. in some embodiments) and may exhibit thermal radiation over various wavelength ranges during normal operation of furnace 100. In some embodiments, temperatures in excess of approximately 450 degrees C. may be outside normal operation and may be associated with temperature abnormalities resulting from coking, scaling, and/or other problems associated with furnace tubes 110.

In some embodiments, gases 130 (e.g., illustrated as several gas plumes) may flow from burners 120 out through a vent 102. However, gases 130 will generally flow in a highly turbulent and unpredictable manner. For example, gases 130 may exist as gas plumes that are temporarily positioned in front of various surfaces of furnace tubes 110 as shown in FIG. 1.

In some embodiments, gases 130 may exhibit higher temperatures than furnace tubes 110 (e.g., in excess of 700 degrees C. in some embodiments) and exhibit thermal radiation over various wavelength ranges that differ from each other and also differ from that of furnace tubes 110.

If left unfiltered, thermal images captured by imaging system 150 of an interior portion of furnace 100 may provide only a partial view of furnace tubes 110. In this regard, the thermal radiation of high temperature gases 130 may obscure the thermal radiation of lower temperature furnace tubes 110 in unfiltered thermal images captured by imaging system 150.

As gases 130 flow unpredictably through furnace 100, their locations can shift as imaging system 150 captures additional thermal images. For example, successively captured thermal images may result in different portions of furnace tubes 110 being exposed and obscured as gases 130 expand, contract, translate, and/or otherwise move.

As further discussed herein, a tunable filter of imaging system 150 may be used to substantially attenuate (e.g., filter out) the wavelength ranges of thermal radiation associated with gases 130 and thereby capture clearer thermal images of furnace tubes 110 for inspection and temperature measurement thereof.

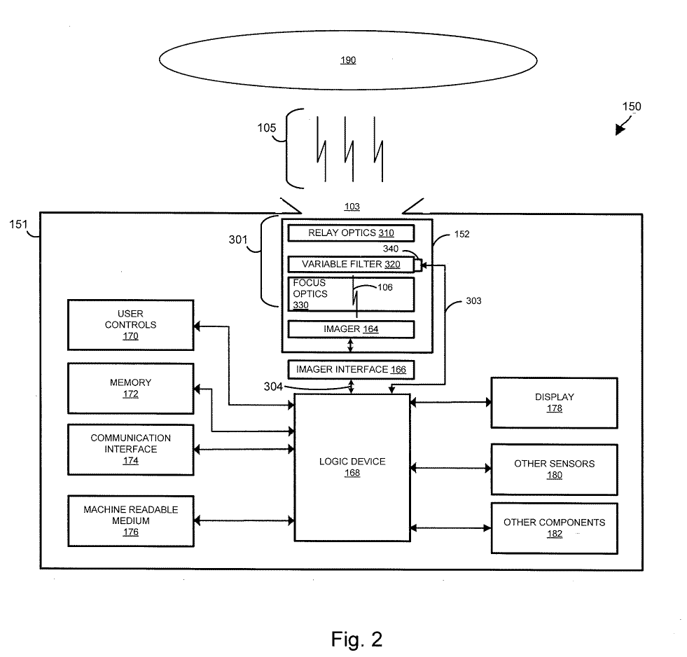

FIG. 2 illustrates a block diagram of imaging system 150 in accordance with an embodiment of the disclosure. As shown, imaging system 150 includes a housing 151 (e.g., a camera body) having an aperture 103. Imaging system 150 further includes an optical system 301 including relay optics 310, a tunable filter 320 (e.g., having a passband adjustable by one or more actuators 340), and focus optics 330. Imaging system 150 further includes an imager 164, an imager interface 166, a logic device 168, user controls 170, a memory 172, a communication interface 174, a machine readable medium 176, a display 178, other sensors 180, and other components 182.

In various embodiments, imaging system 150 may be implemented, for example, as a camera system such as a portable handheld camera system, a small form factor camera system implemented as part of another device, a fixed camera system, and/or other appropriate implementations. Imaging system 150 may be positioned to receive thermal radiation 105 from a scene 190 (e.g., a field of view of imaging system 150). In various embodiments, scene 190 may include an interior portion of furnace 100 including furnace tubes 110 (e.g., as shown in FIG. 1).

Optical system 301 receives thermal radiation 105 received from scene 190 by relay optics 310 through aperture 103, filters the thermal radiation 105 by filter 320 to provide filtered thermal radiation 106, and passes the filtered thermal radiation 106 to imager 164 through focus optics 330.

Imager 164 may be implemented as a thermal imager to capture thermal images of the filtered thermal radiation 106. Imager 164 may include an array of sensors for capturing thermal images (e.g., thermal image frames) of scene 190. In some embodiments, imager 164 may also include one or more analog-to-digital converters for converting analog signals captured by the sensors into digital data (e.g., pixel values) to provide the captured images. Imager interface 166 provides the captured images to logic device 168 through one or more signals 304. Logic device 168 may be used to process the images, store the original and/or processed images in memory 172, and/or retrieve stored images from memory 172.

In some embodiments, imager 164 may be implemented with a short integration time (e.g., less than 10 milliseconds) to permit the rapid capture of thermal images as a passband of filter 320 is adjusted.

In some embodiments, imaging system 150 may be implemented as a cooled camera such that one or more components of optical system 301 and/or imager 164 may be provided in a cooled enclosure 152 (e.g., a dewar or other appropriate implementation) to provide improved accuracy in temperature measurements determined from the captured thermal images (e.g., as a result of less stray light being received by imager 164 and therefore higher achievable transmittance values).

For example, in some embodiments, optical system 301 may be implemented with a relatively small size (e.g., by using a MEMS-based or piezoelectric based Fabry-Perot interferometer for filter 320 as discussed herein) to permit optical system 301 and imager 164 to be provided in cooled enclosure 152. In this regard, optical system 301 (including relay optics 310, tunable filter 320 implemented as a Fabry-Perot interferometer, and focus optics 330) and imager 164 may all be provided inside a dewar implemented by cooled enclosure 152 and illustrated in FIG. 2.

In some embodiments, a wide cold filter may be provided outside of cooled enclosure 152 (e.g., with a passband of 3.2 μm to 4.16 μm or other ranges as appropriate). In some embodiments, imaging system 150 may be implemented as an uncooled camera without cooled enclosure 152.

Logic device 168 may include, for example, a microprocessor, a single-core processor, a multi-core processor, a microcontroller, a programmable logic device configured to perform processing operations, a digital signal processing (DSP) device, one or more memories for storing executable instructions (e.g., software, firmware, or other instructions), and/or any other appropriate combinations of devices and/or memory to perform any of the various operations described herein. Logic device 168 is configured to interface and communicate with the various components of imaging system 150 to perform various method and processing steps described herein. In various embodiments, processing instructions may be integrated in software and/or hardware as part of logic device 168, or code (e.g., software and/or configuration data) which may be stored in memory 172 and/or a machine readable medium 176. In various embodiments, the instructions stored in memory 172 and/or machine readable medium 176 permit logic device 168 to perform the various operations discussed herein and/or control various components of system 150 for such operations.

Memory 172 may include one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, fixed memory, removable memory, and/or other types of memory.

Machine readable medium 176 (e.g., a memory, a hard drive, a compact disk, a digital video disk, or a flash memory) may be a non-transitory machine readable medium storing instructions for execution by logic device 168. In various embodiments, machine readable medium 176 may be included as part of imaging system 150 and/or separate from imaging system 150, with stored instructions provided to imaging system 150 by coupling the machine readable medium 176 to imaging system 150 and/or by imaging system 150 downloading (e.g., via a wired or wireless link) the instructions from the machine readable medium (e.g., containing the non-transitory information).

Logic device 168 may be configured to process captured images and provide them to display 178 for presentation to and viewing by the user. Display 178 may include a display device such as a liquid crystal display (LCD), an organic light-emitting diode (OLED) display, and/or other types of displays as appropriate to display images and/or information to the user of system 150. Logic device 168 may be configured to display images and information on display 178. For example, logic device 168 may be configured to retrieve images and information from memory 172 and provide images and information to display 178 for presentation to the user of system 150. Display 178 may include display electronics, which may be utilized by logic device 168 to display such images and information.

User controls 170 may include any desired type of user input and/or interface device having one or more user actuated components, such as one or more buttons, slide bars, knobs, keyboards, joysticks, and/or other types of controls that are configured to generate one or more user actuated input control signals. In some embodiments, user controls 170 may be integrated with display 178 as a touchscreen to operate as both user controls 170 and display 178. Logic device 168 may be configured to sense control input signals from user controls 170 and respond to sensed control input signals received therefrom. In some embodiments, portions of display 178 and/or user controls 170 may be implemented by appropriate portions of a tablet, a laptop computer, a desktop computer, and/or other types of devices.

In various embodiments, user controls 170 may be configured to include one or more other user-activated mechanisms to provide various other control operations of imaging system 150, such as auto-focus, menu enable and selection, field of view (FoV), brightness, contrast, gain, offset, spatial, temporal, and/or various other features and/or parameters.

Imaging system 150 may include various types of other sensors 180 including, for example, motion sensors (e.g., accelerometers, vibration sensors, gyroscopes and/or others), microphones, navigation sensors (e.g., global positioning system (GPS) sensors), temperature sensors, and/or other sensors as appropriate.

Logic device 168 may be configured to receive and pass images from imager interface 166, additional data from sensors 180, and control signal information from user controls 170 to one or more external devices through communication interface 174 (e.g., through wired and/or wireless communications). In this regard, communication interface 174 may be implemented to provide wired communication over a cable and/or wireless communication over an antenna. For example, communication interface 174 may include one or more wired or wireless communication components, such as an Ethernet connection, a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components configured for communication with a network. As such, communication interface 174 may include an antenna coupled thereto for wireless communication purposes. In other embodiments, the communication interface 174 may be configured to interface with a DSL (e.g., Digital Subscriber Line) modem, a PSTN (Public Switched Telephone Network) modem, an Ethernet device, and/or various other types of wired and/or wireless network communication devices configured for communication with a network.

In some embodiments, a network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) configured to communicate with other communication networks, such as the Internet. As such, in various embodiments, imaging system 150 and/or its individual associated components may be associated with a particular network link such as for example a URL (Uniform Resource Locator), an IP (Internet Protocol) address, and/or a mobile phone number.

Imaging system 150 may include various other components 182 such as speakers, displays, visual indicators (e.g., recording indicators), vibration actuators, a battery or other power supply (e.g., rechargeable or otherwise), and/or additional components as appropriate for particular implementations.

Although various features of imaging system 150 are illustrated together in FIG. 2, any of the various illustrated components and subcomponents may be implemented in a distributed manner and used remotely from each other as appropriate.

Although imaging system 150 has been described in the context of a thermal imaging system, other embodiments are also contemplated. In some embodiments, optical system 301 and/or imager 164 may be implemented to pass and capture other wavelengths such as visible light wavelengths in addition to or instead of thermal wavelengths. For example, imaging system 150 may be implemented to capture both thermal images and visible light images of scene 190 for comparison with each other to detect scaling or other phenomena. As another example, different imaging systems 150 implemented for different wavelengths may be used to capture thermal images and visible light images of scene 190.

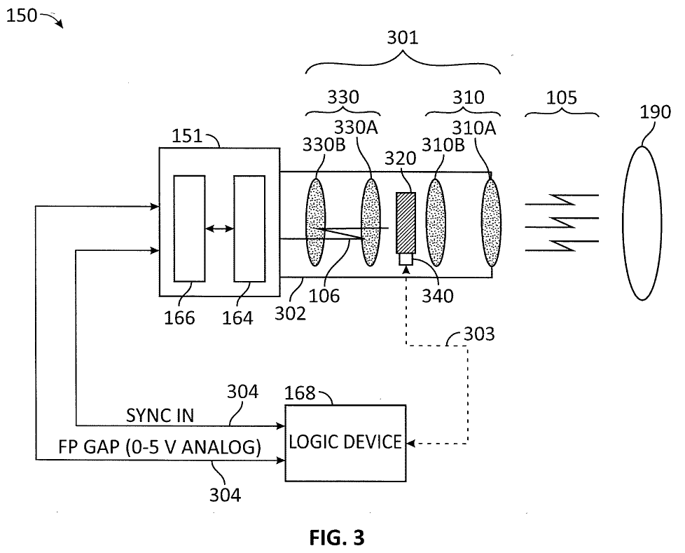

FIG. 3 illustrates an additional block diagram of imaging system 150 in accordance with an embodiment of the disclosure. In FIG. 3, for ease of review and further clarity, various portions of imaging system 150 are illustrated in further detail and/or in alternative implementations, while other portions of imaging system 150 are omitted in comparison with FIG. 1.

For example, as previously discussed, optical system 301 may be disposed within housing 151 and behind aperture 103 of housing 151 as illustrated in FIG. 1. In FIG. 3, optical system 301 is provided, for example, in a lens barrel 302 attached to housing 151 with aperture 103 positioned at the end of lens barrel 302.

As shown in FIG. 3, optical system 301 receives thermal radiation 105 from scene 190. Relay optics 310 is implemented with individual relay lenses 310A/310B which operate to pass thermal radiation 105 to filter 320. Although two relay lenses 310A/310B are illustrated, greater or fewer lenses may be provided as appropriate.

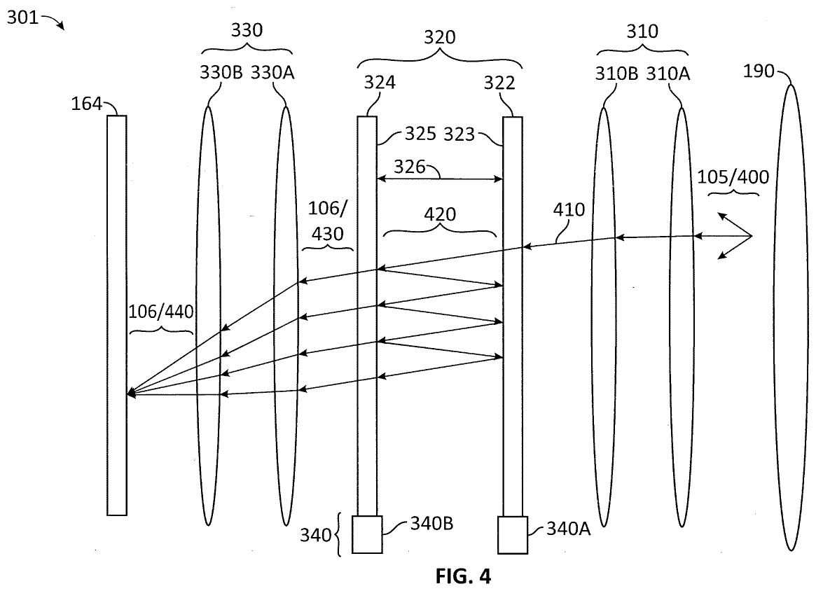

Filter 320 may be implemented as any appropriate tunable filter with a passband that may be selectively adjusted to filter thermal radiation 105 over various narrow wavelength ranges to provide filtered thermal radiation 106. For example, in some embodiments, filter 320 may be implemented as a Fabry-Perot interferometer (e.g., as illustrated in FIGS. 3 and 4), a filter wheel, or other appropriate filter type.

Filter 320 may be implemented, for example, with a passband having a center wavelength that may be adjusted (e.g., the center wavelength of the passband may be continuously swept) over a range of thermal wavelengths to provide filtered thermal radiation 106 for subsets of the thermal wavelengths. In some embodiments, the passband may have a width of 100 nm that is swept over a thermal wavelength range of 3.55 μm to 4.05 μm. Thus, it will be appreciated that such implementations will cause filtered thermal radiation 106 to include only a narrow subset of thermal wavelengths within the overall available thermal wavelength range.

In some embodiments, an upper end of the range (e.g., 4.05 μm) may correspond to thermal wavelengths where various combustion gases (e.g., carbon dioxide and/or other combustion gases) exhibit very substantial thermal radiance. In this regard, thermal images captured for thermal wavelengths above the upper end may be sufficiently saturated with thermal radiance associated with combustion gases 130 such that furnace tubes 110 are generally obscured by combustion gases 130 under most operating conditions of furnace 100. In some embodiments, a lower end of the range (e.g., 3.55 μm) may be determined by the available width of gap 326 of filter 320 (e.g., shown in FIG. 4).

In embodiments where filter 320 is a Fabry-Perot interferometer, relay optics 310 may operate to pass the rays of thermal radiation 105 at an appropriate acceptance angle (e.g., approximately 10 degrees or other angles) to be received by filter 320.

Actuators 340 may be controlled by logic device 168 by one or more signals 303 to adjust (e.g., select) the passband of filter 320. For example, in embodiments where filter 320 is a Fabry-Perot interferometer, actuators 340 may translate or otherwise move one or more plates of the Fabry-Perot interferometer to adjust the passband as further discussed with regard to FIG. 4. Actuators 340 may be implemented, for example, as Micro-Electro-Mechanical Systems (MEMS) actuators, piezoelectric actuators, and/or other types as appropriate.

Focus optics 330 is implemented with individual focus lenses 330A/330B which operate to focus the filtered thermal radiation 106 on imager 164. Although two focus lenses 330A/330B are illustrated, greater or fewer lenses may be provided as appropriate.

As discussed, imager 164 captures thermal images of the filtered thermal radiation 106 and provides the captured thermal images to logic device 168 through imager interface 166. As illustrated, imager interface 166 and logic device 168 communicate with each other through one or more signals 304.

Thus, imager 164, imager interface 166, signals 304, logic device 168, signals 303, and filter 320 provide a feedback loop such that filter 320 may be adjusted in response to the processing performed by logic device 168 on thermal images captured by imager 164. This adjustment of filter 320 affects the additional thermal images captured by imager 164 which can be further processed by logic device 168 to further adjust filter 320.

FIG. 4 illustrates filter 320 and other features of optical system 301 in accordance with an embodiment of the disclosure. As shown, thermal radiation 105 (rays 400) passes from scene 190 to relay lenses 310A/310B of relay optics 310. Thermal radiation 105 may be diffuse and exhibit a range of incidence angles. Relay lenses 310A/310B adjust the angle of thermal radiation 105 to provide ray 410 having an appropriate acceptance angle (e.g., approximately 10 degrees or other angles) to be received by filter 320.

In the embodiment of FIG. 4, filter 320 is implemented as a Fabry-Perot interferometer having plates 322 and 324 with parallel reflective surfaces 323 and 325, respectively separated by an adjustable gap 326. As discussed, other embodiments such as a filter wheel are also contemplated.

In the illustrated example Fabry-Perot implementation, thermal radiation 105 (ray 410) passes from relay lenses 310A/310B through plate 322 and is partially reflected back and forth between surfaces 323 and 325 (rays 420) and partially passes through plate 324 (rays 430). Although a particular number of reflections and rays 420 are illustrated, any desired number may be implemented. Focus lenses 330A/330B receive rays 430 and focus them to provide rays 440 which are received together at a location on an image plane of imager 164.

The various rays 440 received by imager 164 will be delayed relative to each other as determined by the width of gap 326. As a result, rays 440 will constructively and destructively interfere with each other when received by imager 164 to cause the collective sum of rays 440 to be filtered to a passband determined by gap 326. Thus, the passband of filter 320 may be adjusted by adjusting the width of gap 326.

Actuators 340 are implemented as individual actuators 340A and 340B associated with plates 322 and 324, respectively. In response to signals 303 received from logic device 168, one or both of actuators 340A and/or 340B may cause plates 322 and/or 324 to translate relative to each other to adjust the width of gap 326 therebetween, and therefore also adjust the passband of filter 320 as discussed. Although filter 320 is described as being adjusted by actuators 340A/340B, it is also contemplated that direct or indirect manual adjustment by a user may be performed.

As discussed, various fuels may be used for furnace 100 which may result in various combustion gases 130. In some embodiments, such combustion gases 130 may include, but are not limited to, one or more of the following gases in Table 1:

TABLE 1

sulfur dioxide (SO₂)
nitrous oxide (N₂O)
water vapor (H₂O)
carbon dioxide (CO₂)
carbon monoxide (CO)
methane (CH₄)
nitric oxide (NO)
nitrogen dioxide (NO₂)
oxygen (O₂)
nitrogen (N₂)
hydrogen sulfide (H₂S)
hydrogen (H₂)
ethylene (C₂H₄)
ethane (C₂H₆)
propylene (C₃H₆)
propane (C₃H₈)
butylene (C₄H₈)
(e.g., isobutylene,
trans-2-butene,
cis-2-butene)
isobutane (IC₄H₁₀)
N-butane (NC₄H₁₀)
1-pentene (C₅H₁₀)
isopentane (IC₅H₁₂)
N-pentane (NC₅H₁₂)
N-hexane (NC₆H₁₄)

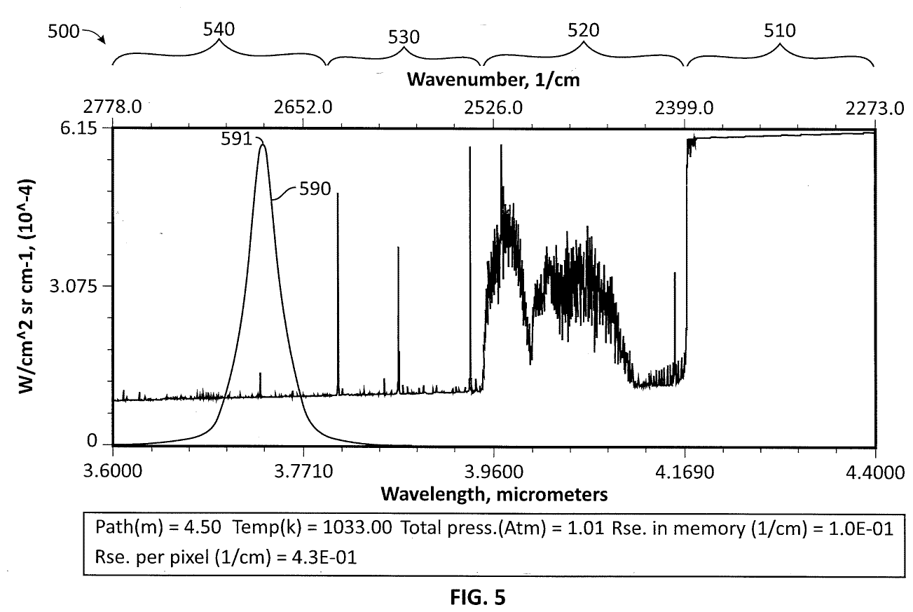

Accordingly, FIGS. 5-7 illustrate thermal radiance plots of various combustion gases in accordance with embodiments of the disclosure. In particular, the plots of FIGS. 5-7 identify the intensity of thermal radiation 105 (e.g., thermal radiance) emitted by various combustion gases at a temperature of 760 degrees C. (1033 degrees K) across different wavelengths. Also in FIGS. 5-7, example adjustments of a passband 590 (e.g., having a center wavelength 591) of tunable filter 320 are also shown as further discussed herein.

FIG. 5 illustrates a plot 500 identifying the thermal radiance of sulfur dioxide (SO₂) gas. Wavelength ranges 510 and 520 exhibit substantial thermal radiance associated with sulfur dioxide gas. Wavelength range 530 exhibits intermediate thermal radiance associated with sulfur dioxide gas. Wavelength range 540 exhibits relatively little thermal radiance associated with sulfur dioxide gas.

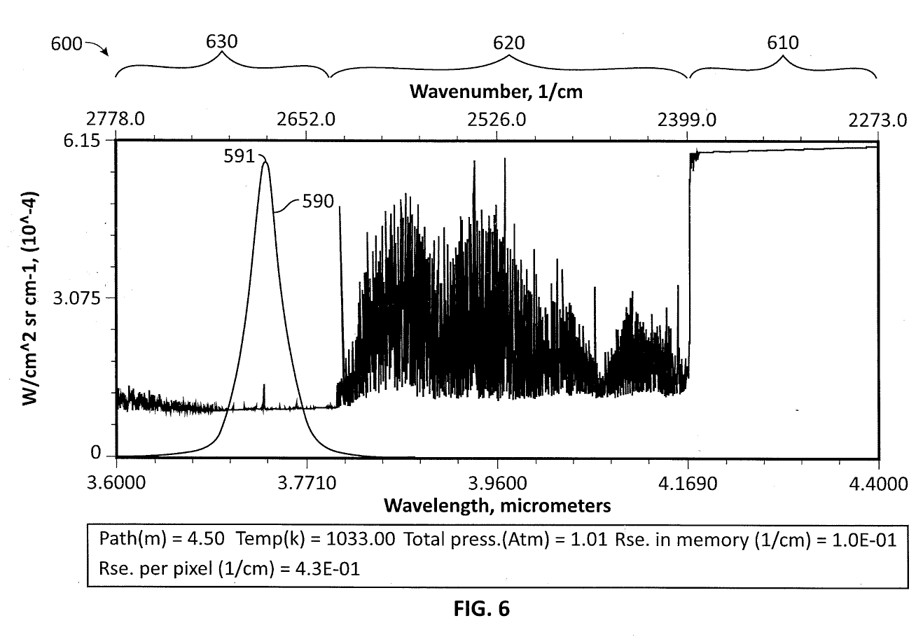

FIG. 6 illustrates a plot 600 identifying the thermal radiance of nitrous oxide (N₂O) gas. Wavelength ranges 610 and 620 exhibit substantial thermal radiance associated with nitrous oxide gas. Wavelength range 630 exhibits relatively little thermal radiance associated with nitrous oxide gas.

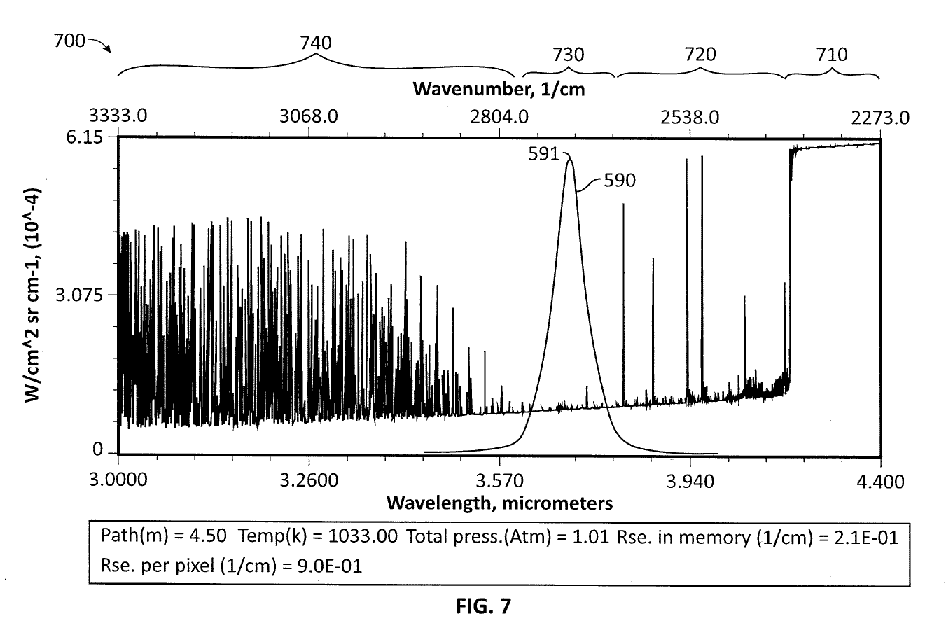

FIG. 7 illustrates a plot 700 identifying the combined thermal radiance of water vapor (H₂O) and carbon dioxide gas (CO₂). Wavelength range 710 exhibits substantial thermal radiance associated with carbon dioxide gas. Wavelength range 720 exhibits intermediate thermal radiance associated with water vapor. Wavelength range 730 exhibits relatively little thermal radiance associated with either carbon dioxide gas or water vapor. Wavelength range 740 exhibits substantial thermal radiance associated with water vapor.

As shown in FIGS. 5-7, the thermal radiance exhibited different combustion gases can vary greatly over different wavelength ranges. Such variation can affect the thermal images captured of scene 190 within furnace 100 when combustion gases are present.

For example, if sulfur dioxide gas is present in furnace 100, then furnace tubes 110 are likely to be substantially obscured by the sulfur dioxide gas for thermal images captured of wavelength ranges 510 and 520. In contrast, furnace tubes 110 are likely to be far more visible for thermal images captured of a portion of wavelength range 530 and all of wavelength range 540 (e.g., the thermal radiance of sulfur dioxide gas is substantially reduced in wavelength ranges 530 and 540, and therefore less likely to obscure furnace tubes 110). Accordingly, furnace tubes 110 will be visible and sulfur dioxide gas will be reduced in thermal images captured while center wavelength 591 of passband 590 is positioned in wavelength range 540 as shown in FIG. 5.

Similarly, if nitrous oxide gas is present in furnace 100, then furnace tubes 110 are likely to be substantially obscured by the nitrous oxide gas for thermal images captured of wavelength ranges 610 and 620. In contrast, furnace tubes 110 are likely to be far more visible for thermal images captured of wavelength range 630 (e.g., the thermal radiance of nitrous oxide gas is substantially reduced in wavelength range 630, and therefore less likely to obscure furnace tubes 110). Accordingly, furnace tubes 110 will be visible and nitrous oxide gas will be reduced in thermal images captured while center wavelength 591 of passband 590 is positioned in wavelength range 630 as shown in FIG. 6.

Likewise, if water vapor and carbon dioxide gas are present in furnace 100, then furnace tubes 110 are likely to be substantially obscured by the carbon dioxide gas for thermal images captured of wavelength range 710, partially obscured by water vapor for thermal images captured of wavelength range 720, and substantially obscured by water vapor for thermal images captured of wavelength range 740. In contrast, furnace tubes 110 are likely to be far more visible for thermal images captured of wavelength range 730 (e.g., the thermal radiance of carbon dioxide and water vapor is substantially reduced in wavelength range 730, and therefore less likely to obscure furnace tubes 110). Accordingly, furnace tubes 110 will be visible and water vapor and carbon dioxide gas will be reduced in thermal images captured while center wavelength 591 of passband 590 is positioned in wavelength range 730 as shown in FIG. 7.

Accordingly, by selectively adjusting passband 590 of filter 320 to capture thermal images of wavelength ranges where thermal radiance of the combustion gases 130 is reduced, furnace tubes 110 may be imaged with improved clarity without interference from the various combustion gases. In particular, as further discussed herein, center wavelength 591 of passband 590 may be swept through various wavelength ranges while thermal images are captured to determine one or more center wavelengths 591 for which furnace tubes 110 are imaged with maximum transmittance. Moreover, the techniques discussed herein may be used when a plurality of different combustion gases 130 are present with overlapping and/or different wavelength ranges exhibiting associated thermal radiance.

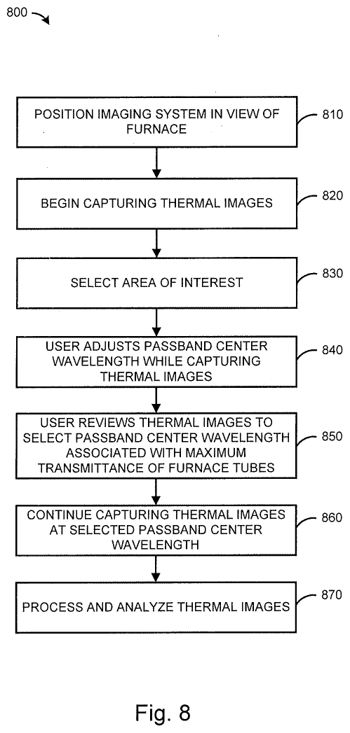

Various techniques of operating imaging system 150 will now be discussed. For example, FIG. 8 illustrates a process 800 of manually adjusting passband 590 of filter 320 for capturing thermal images of furnace tubes 110 in accordance with an embodiment of the disclosure.

In block 810, a user positions imaging system 150 in view of furnace tubes 110. For example, a user may position a camera implementing imaging system 150 at opening 104 of furnace 100 in view of scene 190 that includes furnace tubes 110 and combustion gases 130.

In block 820, imager 164 begins capturing thermal images of scene 190. For example, in some embodiments, the user may manipulate user controls 170 to cause imager 164 to begin the thermal image capturing. In some embodiments, block 820 may be performed without user interaction (e.g., automatically by imaging system 150 in response to being positioned in block 810).

In block 830, the user selects an area of interest in scene 190. For example, the user may review one or more of the captured thermal images and may select a portion of the thermal images corresponding to one or more furnace tubes 110 for which a temperature measurement is desired.

In block 840, the user adjusts the center wavelength 591 of passband 590. For example, if filter 320 is implemented as a Fabry-Perot interferometer, the user may adjust the position of plate 322 and/or plate 324 to increase or decrease gap 326. As a result, the center wavelength 591 of passband 590 may be swept (e.g., continuously swept) by the user over a wavelength range while imaging system 150 continues to capture thermal images of scene 190 using the narrow passband 590 centered at various wavelengths. If filter 320 is implemented by a filter wheel, the user may select among various filters and capture thermal images therewith.

In some embodiments, block 840 may include a direct physical manipulation by the user on filter 320 (e.g., physical adjustment of a mechanical apparatus by the user). In some embodiments, block 840 may include the user interacting with user controls 170 to cause logic device 168 to operate actuator 340A and/or actuator 340B.

In block 850, the user reviews the captured thermal images associated with the different adjustments of passband 590 to select (e.g., identify) passband wavelengths where furnace tubes 110 exhibit maximum radiance (e.g., a narrow captured wavelength range where furnace tubes 110 are highly visible and combustion gases 130 are substantially attenuated and therefore not obscuring furnace tubes 110).

As discussed, different combustion gases may exhibit thermal radiance at different wavelengths. Accordingly, by adjusting the passband until furnace tubes 110 are highly visible, the user may effectively filter out combustion gases 130 from the captured thermal images, even if the user does not know what types of combustion gases are present or what types of fuels are being used by furnace 100.

In some embodiments, blocks 840 and 850 may be performed simultaneously as the user adjusts passband 590 over a wide wavelength range (block 840) and reviews the resulting thermal images (block 850).

Upon completion of block 850, the user will have selected the center wavelength 591 for passband 590 that is associated with maximum transmittance of furnace tubes 110 (e.g., corresponding to minimum obscuration by combustion gases 130).

In block 860, imager 164 continues capturing thermal images at the selected position of passband 590.

In block 870, logic device 168 processes the thermal images captured in block 860. For example, in some embodiments, block 870 may include determining a temperature of one or more furnace tubes 110 associated with the area of interest identified in block 830 (e.g., by converting radiance associated with the captured thermal images to temperature).

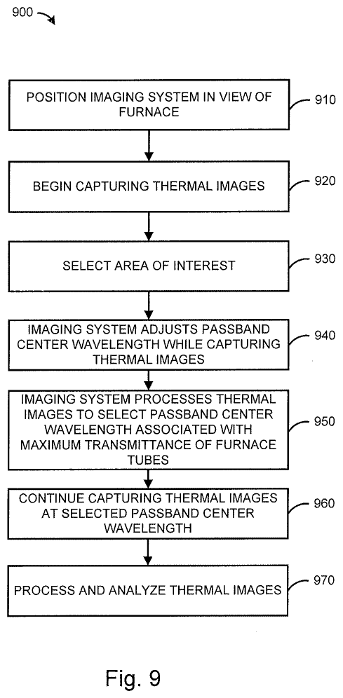

FIG. 9 illustrates a process 900 of adjusting passband 590 of filter 320 by logic device 168 for capturing thermal images of furnace tubes 110 in accordance with an embodiment of the disclosure. Blocks 910, 920, and 930 of FIG. 9 may be performed, for example, in the manner discussed for blocks 810, 820, and 830 of FIG. 8, respectively.

In block 940, imaging system 150 adjusts the center wavelength 591 of passband 590. For example, if filter 320 is implemented as a Fabry-Perot interferometer, logic device 168 may operate actuator 340A and/or actuator 340B to adjust the position of plate 322 and/or plate 324 to increase or decrease gap 326. As a result, the center wavelength 591 of passband 590 may be swept (e.g., continuously swept) by logic device 168 over a wavelength range while imaging system 150 continues to capture thermal images of scene 190. If filter 320 is implemented by a filter wheel, logic device 168 may operate the filter wheel to select among various filters and capture thermal images therewith.

In block 950, logic device 168 processes the captured thermal images associated with the different adjustments of passband 590 to select (e.g., identify) a center wavelength 591 of passband 590 where furnace tubes 110 exhibit maximum radiance (e.g., a position where furnace tubes 110 are highly visible and combustion gases 130 are substantially attenuated and therefore not obscuring furnace tubes 100). Various techniques may be used by logic device 168 to determine the maximum radiance.

For example, as discussed, furnace tubes 110 may be at lower temperatures than combustion gases 130. Accordingly, combustion gases 130 will emit hot temperatures at the wavelengths exhibiting thermal radiance in FIGS. 5-7 as discussed (e.g., wavelength ranges 510, 520, 530, 610, 620, 710, 720, and 740), depending on the particular types of combustion gases 130 present.

As a result, in some embodiments, logic device 168 may determine the center wavelength 591 of passband 590 having maximum transmittance by the thermal image that exhibits a lowest average temperature (e.g., the thermal image captured corresponding to a center wavelength 591 of passband 590 where thermal radiation 105 from combustion gases 130 is not captured by imager 164).

In another embodiment, if furnace 100 exhibits normal clean combustion, then furnace tubes 110 will emit thermal radiance broadly with slow intensity variation. In this case, the wavelengths associated with maximum transmittance may be determined by median filtering the captured thermal images. The resulting median filtered images will exhibit slowly varying Planck radiation from furnace tubes 110. The median filtering will reduce the contributions of thermal radiance associated with combustion gases 130 to the median filtered thermal images.

In another embodiment, the maximum transmittance may be determined by further performing linear regression processing on the captured thermal images.

In another embodiment, median filtering and linear regression processing may both be used together to determine the maximum transmittance.

In some embodiments, blocks 940 and 950 may be performed simultaneously as logic device 168 sweeps the center wavelength 591 of passband 590 over a wide wavelength range (block 940) and processes the resulting thermal images (block 950).

Upon completion of block 950, logic device 168 will have selected the passband wavelength range associated with maximum transmittance of furnace tubes 110 (e.g., corresponding to minimum obscuration by combustion gases 130).

Blocks 960 and 970 of FIG. 9 may be performed, for example, in the manner discussed for blocks 860 and 870 of FIG. 8, respectively.

In view of the present disclosure, it will be appreciated that accurate temperature measurements may be determined even in chaotic environments where turbulent gases are present such as the interior portions of hot furnaces. Moreover, the various techniques provided herein may also be used to more accurately and dynamically visualize potential gas leaks and/or other phenomena of interest by reducing the effects of extraneous variations in temperature caused by other environmental factors.

Any of the features of the present disclosure may also be combined with any of the features set forth in U.S. Pat. No. 11,386,530 issued Jul. 12, 2022 entitled “DIGITAL FILTER FOR TURBULENCE REDUCTION AND GAS DETECTION IN THERMAL IMAGES” which is hereby incorporated by reference in its entirety.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
receiving, at a tunable filter, thermal radiation from a furnace comprising a furnace tube and combustion gas;
adjusting a passband of the filter within a range of thermal wavelengths to provide filtered thermal radiation for subsets of the thermal wavelengths;
capturing thermal images of the filtered thermal radiation for the subsets; and
processing the thermal images to select one of the subsets for which the furnace tube exhibits a maximum transmittance relative to the combustion gas.

2. The method of claim 1, wherein the adjusting comprises continuously sweeping a center wavelength of the passband through the range.

3. The method of claim 1, wherein the combustion gas exhibits thermal radiation at a plurality of combustion gas wavelengths within the range and outside the selected subset.

4. The method of claim 1, wherein:
the adjusting is performed manually by a user; and
the processing is performed by the user reviewing the thermal images.

5. The method of claim 1, wherein:
the adjusting is performed by one or more actuators in response to one or more signals received from a logic device; and
the processing is performed by the logic device.

6. The method of claim 1, wherein the processing comprises median filtering the thermal images.

7. The method of claim 6, wherein the processing further comprises performing a linear regression on the thermal images.

8. The method of claim 1, wherein the filter is a Fabry-Perot interferometer or a filter wheel.

9. The method of claim 1, wherein:
the passband has a width of 100 nm; and
the range is 3.55 μm to 4.05 μm.

10. The method of claim 1, wherein:
the method is performed by a thermal imaging camera; and
the method further comprises positioning the thermal imaging camera relative to the furnace.

11. A system comprising:
a tunable filter configured to receive thermal radiation from a furnace comprising a furnace tube and combustion gas, wherein the filter comprises a passband adjustable within a range of thermal wavelengths to provide filtered thermal radiation for subsets of the thermal wavelengths;
an imager configured to capture thermal images of the filtered thermal radiation for the subsets; and
a logic device configured to select one of the subsets for which the furnace tube exhibits a maximum transmittance relative to the combustion gas.

12. The system of claim 11, wherein the passband is configured to be adjusted by continuously sweeping a center wavelength of the passband through the range.

13. The system of claim 11, wherein the combustion gas exhibits thermal radiation at a plurality of combustion gas wavelengths within the range and outside the selected subset.

14. The system of claim 11, wherein:
the passband is configured to be adjusted manually by a user; and
the logic device is configured to select the subset in response to the user.

15. The system of claim 11, further comprising:
one or more actuators configured to adjust the passband in response to one or more signals from the logic device; and
wherein the logic device is configured to process the thermal images to select the subset.

16. The system of claim 11, wherein the logic device is configured to perform median filtering on the thermal images to select the subset.

17. The system of claim 16, wherein the logic device is further configured to perform a linear regression on the thermal images to select the subset.

18. The system of claim 11, wherein the filter is a Fabry-Perot interferometer or a filter wheel.

19. The system of claim 11, wherein:
the passband has a width of 100 nm; and
the range is 3.55 μm to 4.05 μm.

20. The system of claim 11, wherein the system is a thermal imaging camera configured to be positioned relative to the furnace.
